(19) United States
(12) Patent Application Publication
(10) Pub. No.: US 2013/0272711 A1
(43) Pub. Date: Oct. 17, 2013

(54) Light-Tree Provisioning for Multicast Traffic in Flexible Optical WDM Networks

(71) Applicant: NEC LABORATORIES AMERICA, INC., Princeton, NJ (US)

(72) Inventors: Ankitkumar Patel, Monmouth Junction, NJ (US); Philip Nan Ji, Plainsboro, NJ (US); Ting Wang, West Windsor, NJ (US)

(73) Assignee: NEC Laboratories America, Inc., Princeton, NJ (US)

(21) Appl. No.: 13/862,407

(22) Filed: Apr. 13, 2013

Related U.S. Application Data
(60) Provisional application No. 61/623,820, filed on Apr. 13, 2012.

(51) Int. Cl. H04J 14/02

(52) U.S. Cl. CPC H04J 14/0227
USPC 398/79

(57) ABSTRACT

Hybrid application of the generic evolution and simulated annealing methods are used to solve routing, wavelength assignment, and spectrum allocation sub-problems of a light-tree establishment problem in a flexible wavelength division multiplexing FWDM optical network.

### RELATED APPLICATION INFORMATION

This application claims priority to provisional application No. 61/623,820 filed Apr. 13, 2012, the contents thereof are incorporated herein by reference.

### BACKGROUND OF THE INVENTION

The present invention relates generally to optical communications, and more particularly, to a light-tree provisioning for multi-cast traffic in flexible optical wavelength division multiplexing WDM networks.

Wavelength Division Multiplexing (WDM) is a promising technology offering high-speed and high-capacity communications to support the emerging global communications traffic. Major portion of this traffic is mainly contributed by, but not limited to, the applications, such as IPTV, video-conferencing, content distribution, grid applications, database backup, software distributions, interactive gaming, consumer television, and distance learning. Instead of a host communicates with another host, which is referred to as a unicast communication, in such applications, a host communicates to a set of hosts, which is referred to as a multicast communication. In all-optical networks, unicast communications are realized by point-to-point all-optical channels referred to as lightpaths, and multicast communications are realized by point-to-multipoint all-optical channels referred to as light-trees (In light-trees, data is transferred from a source node to a set of destination nodes without any electronic conversion at intermediate nodes). Provisioning multicast applications through light-trees improves network efficiency compared to that through lightpaths due to inherent benefits of light-trees, such as reduced control and management overhead and elimination of traffic redundancy. Furthermore, since a light-tree is a generalization of a lightpath, light-tree based connectivity is more optimized than lightpath based connectivity.

In ITU-T based WDM networks [ITU-T], a light-tree is established by allocating fixed amount of spectrum irrespective of the transmission rate. We refer to such networks as fixed grid networks (FIG. 1(a)). Fixed spectrum assignment to light trees may not be sufficient to support higher line rates. In such case, super-wavelength granularity traffic is supported through multiple light-trees and excessive spectrum needs to be allocated in terms of guard bands to avoid inter-channel interference. The spectrum allocated to guard bands cannot be utilized for data transmission. On the other hand, if light-trees are operating at low line rates, then the assigned spectrum may be excessive. Thus, in fixed grid networks, spectrum efficiency may not be optimized due to rigid spectrum assignment to light-trees.

There has been growing research interests on optical WDM systems that are not limited to fixed ITU-T channel grid, but offer flexible channel grid to increase spectral efficiency. We refer to such networks as the Flexible optical WDM networks (FWDM) (FIG. 1(b)). While provisioning light-trees for multicast demands, important problems in the FWDM networks are as follows.

For a given configuration of an optical network in terms of locations of a set of optical nodes V and a set of deployed fibers E connecting optical nodes V, a given set of multicast demands in which a demand R(s, D, r) requests finite data rates r from a source node s to a set of multicast destination nodes D, a set of offered line rates in the network L, and required spectral width xₗ for each line rate l, the problem is (1) how to find a set of all-optical light-trees which can support the given set of traffic demands (logical connectivity sub-problem), (2) how to select line rates of light-trees for each demand to support the requested data rate (line rate selection sub-problem), (3) how to route these light-trees in the network (routing sub-problem), (4) how to assign wavelengths to the light-trees (wavelength assignment sub-problem), and (5) how to allocate spectrum to the light-trees (spectrum allocation sub-problem), such that the required spectrum to support the network traffic is minimized. Together the problems described above is referred to as the light-tree establishment problem in the all-optical flexible WDM networks.

While establishing light-trees in FWDM networks, the control plane must observe (a) the wavelength continuity constraint which is defined as an allocation of the same operating wavelength on all branches of a light tree, (b) the spectral continuity constraint which is defined as an allocation of the same amount of spectrum at an operating wavelength on all branches of a light-tree, and (c) the spectral conflict constraint, which is defined as a non-overlapping spectrum allocation to light-trees routed over the same fiber.

In fixed grid networks, the spectrum assigned to each light-tree is fixed and remains the same for all light-trees. Thus, while establishing light-trees, only wavelength continuity constraint needs to be observed. On the other hand, in FWDM networks, flexible amount of spectrum is allocated to light-trees based on the transmission rate, modulation format, and optical reach. Thus, while establishing light-trees, additional spectral continuity and spectral conflict constraints must be observed. Thus, the light-tree establishment problem in fixed grid networks is a special case of the same problem in FWDM networks. Thus, existing light-tree establishment procedures in fixed grid networks may not be applicable to FWDM networks.

In a prior work, Q. Wang and L-K. Chen, “Performance Analysis of Multicast Traffic over Spectrum Elastic Optical Networks,” IEEE/OSA OFCNFOEC, no.OTh3B.7, March 2012 (QWang), the author proposes a light-tree establishment procedure in FWDM networks for a dynamic traffic scenario in which traffic demands arrive and depart in a probabilistic manner. Thus, demands must be provisioned in the order of their arrivals. In this invention, we investigate the light-tree establishment problem in FWDM networks for a static traffic scenario in which a set of multicast traffic demands are given beforehand. Thus, traffic demands can be provisioned in any order and are not restricted to be provisioned in the order of their arrivals as in the dynamic traffic scenario. Thus, our invention and the procedure in (QWang) address two different problems. Even if we apply the procedure proposed in (QWang) to the light-tree establishment problem of this invention, our invention results in at least as optimum solution as the procedure in (QWang).

To the best of our knowledge, this invention introduces the first procedure, namely a naturally-inspired procedure, to address the static light-tree establishment problem applicable to multicast-enable FWDM networks.

### BRIEF SUMMARY OF THE INVENTION

The present invention is directed to a method, in a flexible optical wavelength division multiplexing FWDM optical network, including employing a genetic evolution procedure for optimizing routing of light-trees for a given set of multicast traffic demands in the FWDM network; and using a simulated annealing procedure to address wavelength assignment and spectrum allocation problems in the FWDM network, wherein the genetic evolution procedure includes a genetic encoding to map a chromosome to a potential solution of the routing sub-problem, a set of light-trees for a given set of traffic demands in the FWDM network representing a chromosome, and an individual light tree within this given set representing a gene, each gene corresponding to a feasible light-tree, and wherein the simulated annealing procedure comprises a configuration C defined as an order of auxiliary demands in which the wavelength and spectrum allocation sub-problems are addresses and an optimization parameter function of C defined as an energy function to be minimized represents a maximum required spectrum over a fiber link including guard bands and fragmentation in observance of wavelength and spectral constraints.

In a network aspect of the invention, a flexible optical wavelength division multiplexing FWDM optical network includes a genetic evolution procedure for optimizing routing of light-trees for a given set of multicast traffic demands in the FWDM network; and a simulated annealing procedure to address wavelength assignment and spectrum allocation problems in the FWDM network, wherein the genetic evolution procedure comprises a genetic encoding to map a chromosome to a potential solution of said routing sub-problem, a set of light-trees for a given set of traffic demands in the FWDM network representing a chromosome, and an individual light tree within this given set representing a gene, each gene corresponding to a feasible light-tree, and wherein the simulated annealing procedure comprises a configuration C defined as an order of auxiliary demands in which the wavelength and spectrum allocation sub-problems are addresses and an optimization parameter function of C defined as an energy function to be minimized represents a maximum required spectrum over a fiber link including guard bands and fragmentation in observance of wavelength and spectral constraints.

These and other advantages of the invention will be apparent to those of ordinary skill in the art by reference to the following detailed description and the accompanying drawings.

### BRIEF DESCRIPTION OF THE DRAWINGS

FIG. 1 depicts fixed transmission channel spacing and flexible transmission channel spacing to which the inventive method is directed;

FIG. 2 shows a genetic encoding pattern representative of a naturally inspired procedure;

FIG. 3 is a flow diagram of the naturally inspired procedure, in accordance with the invention; and

FIG. 4 is a flow diagram of a K-Steiner procedure, in accordance with the invention.

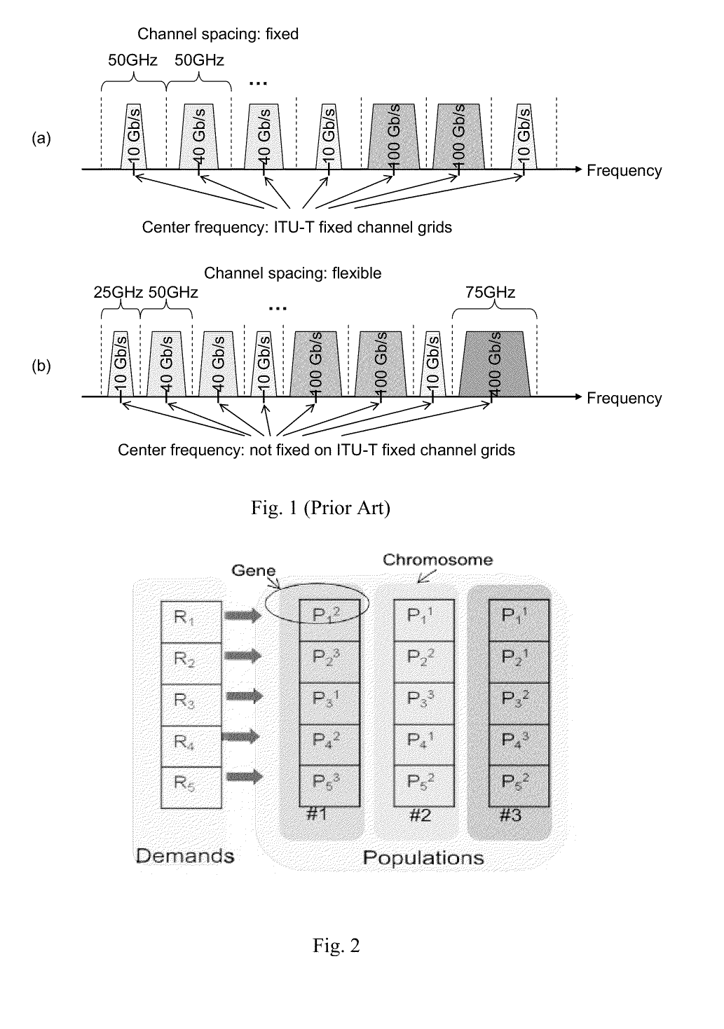

### DETAILED DESCRIPTION

The present invention is directed to a novel procedure, namely a naturally-inspired procedure, using hybrid application of genetic evolution and simulated annealing methods. A genetic evolution method is used to address the routing sub-problem and a simulated annealing method is used to address the wavelength assignment and spectrum allocation sub-problems in a sequential manner.

The inventive naturally-inspired procedure addresses the routing sub-problem using the genetic evolution method and the wavelength assignment and spectrum allocation sub-problems using the simulated annealing method sequentially.

We first introduce some terminologies to explain the naturally-inspired procedure. In the genetic evolution method, a genetic encoding is used to map a chromosome to a potential solution of the problem. A set of light-trees for a given set of traffic demands represents a chromosome, and an individual light tree within this set represents a gene. Thus, each gene corresponds to a feasible light-tree Pᵢ^{j}, where j indexes one of the potential light-trees of a request i as shown in FIG. 2. The fitness of a chromosome is defined as the maximum required spectrum on a fiber link in the network while ignoring the wavelength and spectral continuity constraints,

$${max}_{( m , n ) ∈ E} {Σ}_{\{ i \vert ( m , n ) ∈ {P}_{i}^{j} \}} {Q}_{( m , n )}^{i} ,$$

where Q_{(m, n)}ⁱ denotes the optimum required spectrum for a demand i routed over link (m, n). The genetic evolution method within the naturally-inspired procedure performs the following operations to optimize routing of light-trees for a given set of multicast traffic demands.

Generation of an auxiliary set of traffic demands: Initially, an auxiliary set of traffic demands are constructed from the given set of traffic demands. For each given demand Rᵢ(s, D, r), the rate selection procedure [APatel-IR] is used to determine an optimal set of line rates Lᵢ that supports the requested data rate such that the total required spectrum is minimized. A set of auxiliary demands R′ⱼ(s, D, l) is generated by considering each line rate l ∈ Lᵢ between the same source node and the same set of destination nodes of the demand Rᵢ.

Population generation: Population is a set of chromosomes. Once auxiliary demands are generated, for each auxiliary demand, a Steiner tree is randomly selected out of K-alternate Steiner trees of the demand as a gene to form a chromosome, where K-alternate Steiner trees are obtained through K-Steiner tree procedure described in Flowchart 4. Thus, each chromosome consists of a tree for each auxiliary traffic demand. The number of chromosomes represents the population size.

Selection of chromosomes: The Roulette Wheel Selection method is used in which parent chromosomes are selected with probability

$$\frac{{f}_{i}}{{\sum }_{j = 1}^{j = N} {f}_{j}} ,$$

where fᵢ represents the fitness of a chromosome and N represents the number of chromosomes in the population.

Crossover of parent chromosomes: To bring diversity in the population, a crossover operation is performed over the selected parent chromosomes. Based on the given crossover ratio, a number of chromosome segments (a group of genes) are selected randomly. The selected segments are exchanged between parent chromosomes to generate new children chromosomes.

Mutation: To increase the diversity in the population, the children chromosomes are muted. Based on the given mutation ratio, a number of genes are randomly selected. The trees of the selected genes are replaced by one of the K-alternate Steiner trees of the respective auxiliary demand with the given mutation probability. The muted children chromosomes represent feasible solutions of the problem.

Population upgrade: Fitness of the children chromosomes is evaluated. If a child chromosome has higher fitness than fitness of any existing chromosome in the population, then the child chromosome replaces the chromosome with lowest fitness in order to keep the constant population size.

The genetic evolution method stops when variation in the best fitness of the population in a given number of subsequent iterations remains negligible or the method has reached up to maximum number of iterations, otherwise the method is repeated. After completion of the method, genes of the chromosome with the best fitness represent routings of multicast demands in terms of trees.

The wavelength assignment and spectrum allocation sub-problems are addressed through simulated annealing method. Simulated annealing is a probabilistic iterative method designed based on physical process of annealing of solid. To put the material into low energy state, the material is first heated and later cooled in a controlled manner. The heat causes atoms to displace from their initial position and wander randomly in this high energy state. Slow cooling helps atoms to find the configuration in the material such that internal energy is minimized. Thus, this process can be adopted in optimizing combinatorial problems. In simulated annealing, initially a configuration of the solution is selected. The configuration of the solution is changed randomly and a new configuration is constructed. The new configuration is selected with certain probability that depends on the difference between corresponding optimization parameter (called energy) of the configurations and the global parameter T (called temperature). At higher temperature, probability of selecting a new or current configuration is random, however, as temperature decreases, the probability of selecting a configuration with lower energy (better optimization parameter) increases. Thus, at high temperature, selection of a configuration with worse optimization parameter avoids the method being stuck at local optimization.

In this invention, a configuration C of the procedure is defined as an order of auxiliary demands in which the wavelength and spectrum allocation sub-problems are addressed. The energy function E(C) to be minimized represents the maximum required spectrum over a fiber link including guard bands and fragmentation in observance of the wavelength and spectral continuity constraints. To minimize the energy function, we designed the first-fit spectrum allocation procedure in which an optimum amount of spectrum for an auxiliary demand is allocated at the lowest available wavelength along the links of the trees found in the genetic evolution. This wavelength assignment and spectrum allocation operations are performed using the first fit spectrum allocation procedure in the order of demands defined within the configuration C. A temperature is defined as a global time varying parameter T, and the annealing schedule controls how the temperature T varies over time.

Initial configuration is a random order of auxiliary demands. In each iteration, a new configuration is generated from the current configuration by swapping the order of two neighboring demands selected randomly. The energy of this new configuration E(N) is determined by solving the wavelength assignment and spectrum allocation sub-problems using the first-fit spectrum allocation procedure. If the energy of the new configuration is decreased compare to that of the current configuration, the current configuration is replaced by the new configuration, otherwise the current configuration is replaced by the new configuration with probability

$${e}^{\frac{- ( E ( N ) - E ( C ) )}{T}} ,$$

where T is the current temperature. The process is repeated for maximum iterations per temperature. Once the number of iterations per temperature is completed, the temperature is decreased based on the annealing schedule T=α×T, where 0.9≦α≦0.99. This process is repeated until either the temperature is reduced to 0 or maximum iterations per procedure is completed.

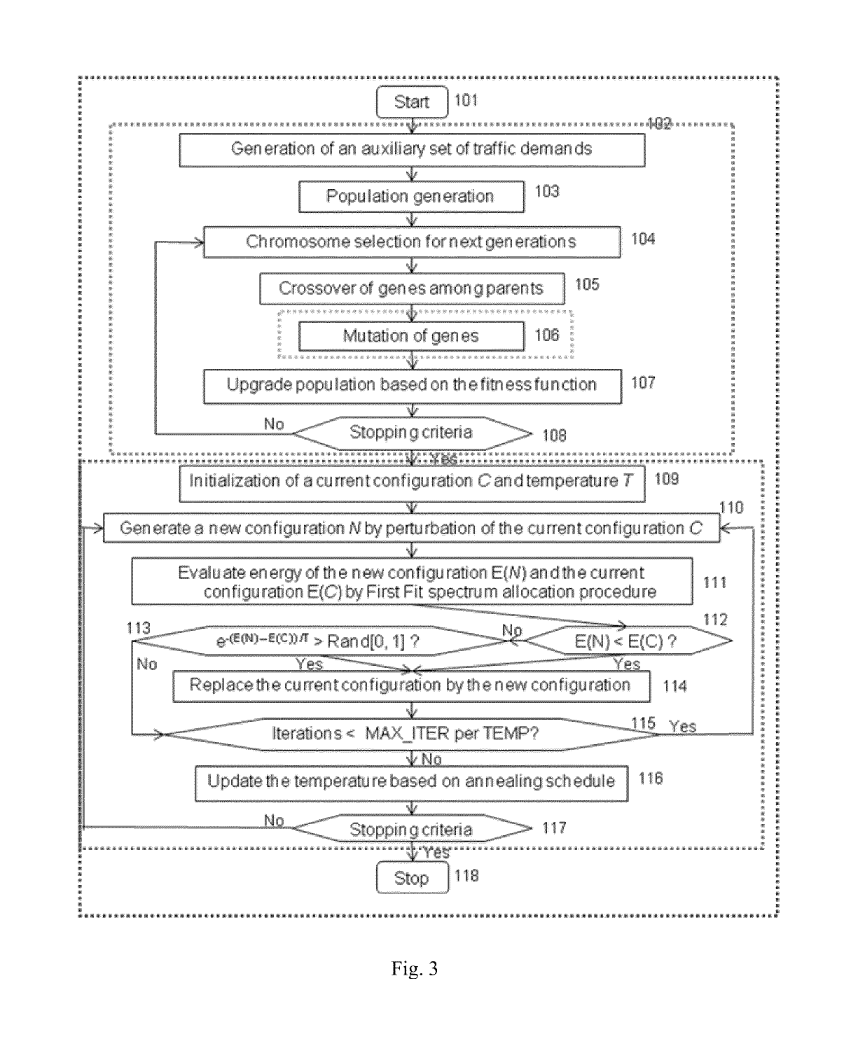

FIG. 3 shows the flow chart of the naturally-inspired procedure in more details and the procedure is explained in detail as follows.

In step 101, the inventive naturally-inspired procedure starts from here. In the next step 102, the inventive procedure finds an auxiliary set of traffic demands from the given set of traffic demands. For each traffic demand Rᵢ(s, D, r), a rate selection procedure is used to determine an optimal set of line rates Lᵢ that supports the requested data rate r such that the total required spectrum is minimized. A set of auxiliary demands R′ᵢ(s, D, l) is generated by considering each line rate l ∈ Lᵢ between the same source s and destination nodes D of the demand Rᵢ.

In step 103, the inventive procedure constructs a population for the genetic evolution method. For each auxiliary demand, a Steiner tree is randomly selected out of K-alternate Steiner trees, connecting a source node s to destination nodes D, as a gene to form a chromosome, where K-alternate Steiner trees are obtained through the K-Steiner tree procedure described in Flowchart 4. Thus, each chromosome consists of a light-tree for each auxiliary demand. Based on the given population size, the number of chromosomes are generated. In the subsequent step 104, parent chromosomes are selected using the Roulette Wheel Selection method.

In step 105, the invention introduces diversity in the population by crossover operation in which based on the given crossover ratio, a number of chromosome segments (a group of genes) are selected randomly. The selected segments are exchanged between parent chromosomes to generate new children chromosomes.

In step 106, the mutation of each novel child chromosome is performed. Based on the given mutation ratio, a number of genes are randomly selected. The light-trees of the selected genes are replaced by one of the K-alternate Steiner trees of the respective auxiliary demand with the given mutation probability.

The invention in step 107 finds the fitness of each child chromosome. If a child chromosome has higher fitness than any existing chromosome in the population, then the child chromosome replaces the chromosome with lowest fitness in order to keep the constant population size.

At step 108, the invention checks whether the improvement in the fitness function is below given threshold since last given number of iterations or the maximum iterations are already reached. If either of these conditions is met, then the procedure follows step 109, otherwise the procedure repeats step 104.

At step 109, there is a selection of a random ordering of auxiliary demands as a current configuration C and initializes the initial temperature T. The next step 110, generates a new configuration N by swapping two neighboring demands that are randomly selected in the current configuration C.

At step 111, inventive procedure finds the energy function of the new configuration N. In this method, energy is defined as the maximum required spectrum over the spectral profile of a fiber link including guard bands and fragmentations. To evaluate the energy, wavelength assignment and spectrum allocation sub-problems are addressed using the first-fit spectrum allocation procedure. In the first-fit spectrum allocation procedure, spectrum is allocated to trees yielded in the genetic evolution method at the lowest available operating wavelengths while observing the wavelength continuity and spectral continuity constraints. The spectrum is allocated to the trees in the order of auxiliary demands defined by the configuration.

The inventive procedure, at step 112, checks whether the energy of the new configuration N is decreased. If the energy of the new configuration is decreased, then the procedure follows step 114, otherwise, the procedure follows step 113.

In step 113, the inventive procedure generates a random number with a uniform distribution and compares it with the probability of a configuration selection,

$${e}^{\frac{- ( E ( N ) - E ( C ) )}{T}}$$

If random number of less than the probability of a configuration selection, then the procedure follows step 114, otherwise the procedure follows step 115.

In step 114, the invention replaces the current configuration C by the new configuration N. In the following step 115, the invention checks whether the number of iterations is reached to the maximum iterations per temperature. If the number of iterations is reached to the maximum iterations, then the procedure follows step 116, otherwise step 110 is repeated.

At step 116, there is an of the temperature based on annealing schedule T=α×T, where 0.9≦α≦0.99.

A step 11, the inventive procedure checks whether the temperature is reached to zero or the number of iterations are reached to the maximum number of iterations per procedure. If any of these conditions is met, then the procedure follows step 118, otherwise step 110 is repeated. Lastly, at step 118, the inventive naturally-inspired procedure is terminated.

K-Steiner tree procedure: The K-Steiner tree procedure addresses the following problem. For a given configuration of an optical network in terms of the locations of a set of optical nodes V and a set of deployed fibers E connecting the optical nodes, a given multicast demand with a source node s and a set of multicast destination nodes D, the problem is how to find K minimum cost Steiner trees connecting the source node to all destination nodes. Here, cost is defined in terms of the length of a tree. The number of fiber links used to form a tree represents the length of the tree.

We investigate K-Steiner tree procedure with the application of K-alternate shortest routes. The identification (ID) Z of a tree is initialized to 1. The procedure first finds K-alternate shortest routes between each pair of nodes and assigns a unique ID to each found path between a pair of nodes. Let denote A to be a set of nodes along the tree, and B denote a set of destination nodes which are not yet connected to the tree. Initially, A is initialized to a source node, and B is initialized to a set of destination nodes. In the next step, the procedure finds a node x from set A, a node d from set B, and a route connecting the pair of nodes (x, d) such that the distance in terms of number of hops between the pair of nodes is minimized. The pair of nodes and the ID of the selected route (x, d, ID) are recorded in a tree C_{Z}, where the subscript denotes the tree ID. The nodes along the found route are included in set A and the destination node d is removed from set B. This procedure is repeated until all destination nodes are connected in the tree. Once all destination nodes are connected to the tree, the tree C_{Z} represents the minimum cost tree out of K-Steiner trees.

Once the first tree C₁ is established. The remaining K−1 trees are constructed by replacing the route between a single pair of nodes in tree C₁ by one of the K-shortest paths those are not yet considered and which results in the least increment of the length of the tree. The route ID of the selected pair of nodes is replaced by the ID of newly found route out of K-shortest routes and the route ID of the rest of pairs remains the same as in the tree C₁, which represents a new tree. The new tree is recoded in set C_{Z}. The procedure increments the ID Z of a tree, and repeats the process for K−1 times.

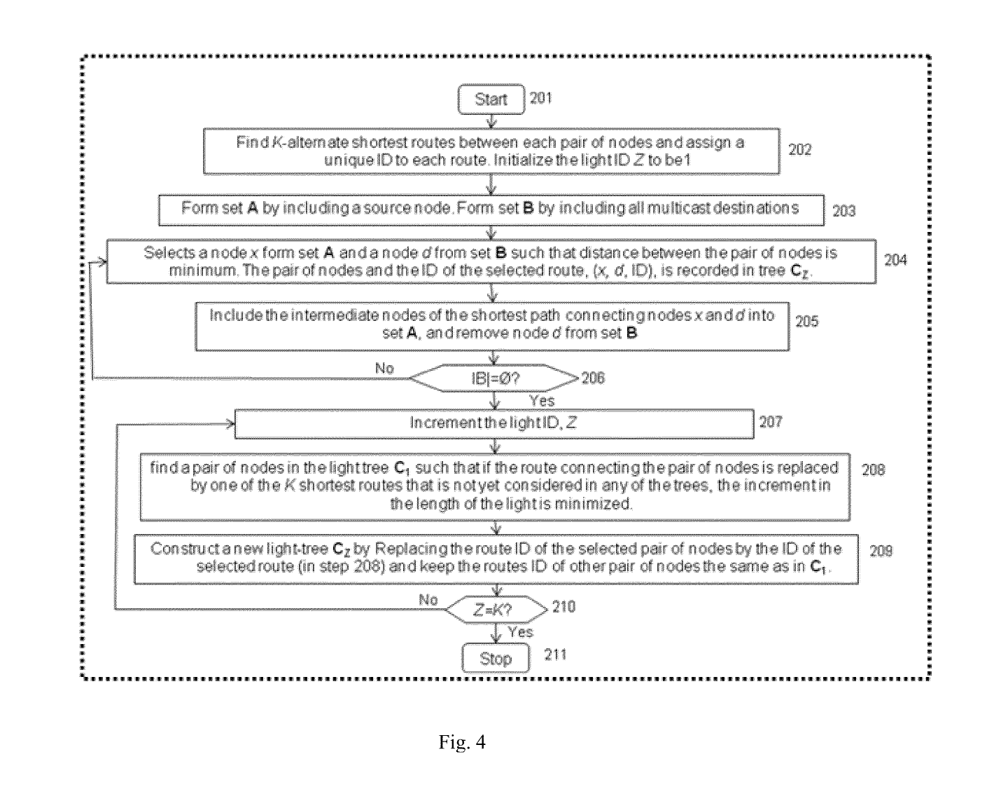

FIG. 4 shows the flowchart of the K-Steiner tree procedure in detail and the procedure is explained in detail as follows. The procedure starts at step 201, and then, at step 201, the procedure finds K-alternate shortest routes between each pair of nodes and assigns a unique ID. The ID of a tree N is initialized to 1.

At step 203, the procedure forms set A by including a source node and set B by including all destination nodes of the demand. In the following step 204, the procedure selects a node x form set A and a node d from set B such that distance between the pair of nodes is minimum. The pair of nodes and the ID of the selected route is recorded in tree C_{Z}.

In step 205, nodes along the route connecting between the selected pair of nodes (x, d) are included in set A and destination node d is removed form set B. The 206 step checks whether all destination nodes from set B are considered. If set B is non-empty, then the procedure repeats step 204, otherwise it follows step 207. The procedure at step 207 increases the tree ID Z.

At step 208, the inventive procedure finds a pair of nodes in a light tree C₁ such that if the route connecting the pair of nodes is replaced by one of the K shortest routes those are not yet considered in any of the light-trees, the increment in the length of a tree is minimized. In the following step 209, the invention constructs a new tree C_{Z} by replacing the route ID of the selected pair of nodes by the ID of the selected route and keeps the routes of other pair of nodes the same as in C₁.

At step 210, there is a check as to whether K trees are found. If the number of found trees is less than K, then the procedure repeats step 207, otherwise the process follows step 211. The K-Steiner tree procedure is terminated at step 211.

From the foregoing it can be appreciated that the naturally-inspired inventive procedure provides for: minimizing the required spectrum in optical networks compared to existing procedures in fixed grid networks to address the light-tree establishment problem; reducing the energy consumption in the optical networks compared to existing procedures in fixed grid networks; minimizing the required spectrum to support multicast traffic compared to lightpath based procedures in FWDM networks; and minimizing the spectrum compared to the procedure proposed in (QWang).

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. In a flexible optical wavelength division multiplexing FWDM optical network, a method for comprising the steps of:
employing a genetic evolution procedure for optimizing routing of light-trees for a given set of multicast traffic demands in said FWDM network; and
using a simulated annealing procedure to address wavelength assignment and spectrum allocation problems in said FWDM network
wherein said genetic evolution procedure comprises a genetic encoding to map a chromosome to a potential solution of said routing sub-problem, a set of light-trees for a given set of traffic demands in said FWDM network representing a chromosome, and an individual light tree within this given set representing a gene, each gene corresponding to a feasible light-tree, and
wherein said simulated annealing procedure comprises a configuration C defined as an order of auxiliary demands in which the wavelength and spectrum allocation sub-problems are addresses and an optimization parameter function of C defined as an energy function to be minimized represents a maximum required spectrum over a fiber link including guard bands and fragmentation in observance of wavelength and spectral constraints.

2. The method of claim 1, wherein fitness of a chromosome is defined as a maximum required spectrum on a fiber link in the FWDM network while ignoring the wavelength and spectral continuity constraints,
$${max}_{( m , n ) ∈ E} {Σ}_{\{ i \vert ( m , n ) ∈ {P}_{i}^{j} \}} {Q}_{( m , n )}^{i} ,$$
where Q_{(m, n)}ⁱ denotes the optimum required spectrum for a demand i routed over link (m, n).

3. The method of claim 1, wherein said genetic evolution procedure comprises generation of an auxiliary set of traffic demands where, initially, an auxiliary set of traffic demands are constructed from said given set of traffic demands, for each given demand Rᵢ(s, D, r), a rate selection procedure being used to determine an optimal set of line rates Lᵢ that supports the requested data rate such that the total required spectrum is minimized and a set of auxiliary demands R′ⱼ(s, D, l) being generated by considering each line rate l ∈ Lᵢ between the same source node and the same set of destination nodes of the demand Rᵢ.

4. The method of claim 1, wherein said genetic evolution procedure comprises population generation, said population being a set of said chromosomes, once auxiliary demands are generated, for each auxiliary demand, a Steiner tree is randomly selected out of K-alternate Steiner trees of the demand as a gene to form a chromosome, each chromosome including a tree for each auxiliary traffic demand, and the number of chromosomes representing the population size.

5. The method of claim 1, wherein said genetic evolution procedure includes a selection of chromosomes comprising a roulette wheel selection in which parent chromosomes are selected with a probability
$$\frac{{f}_{i}}{{\sum }_{j = 1}^{j = N} {f}_{j}} ,$$
where fᵢ represents the fitness of a chromosome and N represents the number of chromosomes in a population represented by a number of chromosomes.

6. The method of claim 1, wherein said genetic evolution procedure comprises a crossover of selected parent chromosomes for bringing diversity in a population of chromosomes, responsive to a given crossover ratio a number of chromosome segments being selected randomly and said selected segments being exchanged between parent chromosomes for generating new children chromosomes.

7. The method of claim 1, wherein said genetic evolution procedure comprises a mutation for increasing diversity in a population of chromosomes by muting children chromosomes, based on a given ratio a number of genes are selected with trees of the selected genes replaced by one of K-alternate Steiner trees of respective auxiliary demand with a given mutation probability, and muted children chromosomes representing feasible solutions of said routing sub-problem.

8. The method of claim 1, wherein said genetic evolution problem comprises a Population upgrade wherein fitness of children chromosomes is evaluated and if a child chromosome has higher fitness than fitness of any existing chromosome in a population, then the child chromosome replaces the chromosome with lowest fitness in order to keep a constant population size.

9. The method of claim 1, wherein said genetic evolution comprises being stopped when variation in a best fitness of a population of chromosomes in a given number of subsequent iterations remains negligible or a maximum number of iterations has been reached and after completion of said genetic evolution method, genes of said chromosome with a best fitness represent routings of multi-cast demands in terms of trees.

10. The method of claim 1 wherein for said simulated annealing procedure to minimize said optimization parameter a first-fit spectrum allocation procedure is used in which an optimum amount of spectrum for an auxiliary demand is allocated at a lowest available wavelength along links of trees found in said genetic evolution procedure.

11. The method of claim 10, wherein said simulated annealing procedure comprises wavelength assignment and spectrum allocations being performed using said first fit spectrum allocation procedure in an order of demands defined within said configuration C and a global time varying parameter and temperature being defined as a global time varying parameter T, and an annealing schedule controls how the temperature T varies over time.

12. The method of claim 11, wherein an initial configuration is a random order of auxiliary demands and in each iteration, a new configuration C is generated from a current configuration by swapping an order of two neighboring demands selected randomly, energy function of this new configuration E(N) being determined by solving said wavelength assignment and spectrum allocation sub-problems using said first-fit spectrum allocation procedure wherein. if the energy of the new configuration is decreased compared to that of the current configuration, the current configuration is replaced by the new configuration, otherwise the current configuration is replaced by the new configuration with probability
$${e}^{\frac{- ( E ( N ) - E ( C ) )}{T}} ,$$
where T is the current temperature.

13. The method of claim 12, once the number of iterations per temperature is completed, the temperature is decreased based on the annealing schedule T=α×T, where 0.9≦α≦0.99, with the decreasing being repeated until either the temperature is reduced to 0 or maximum iterations per procedure is completed.

14. A flexible optical wavelength division multiplexing FWDM optical network comprising:
a genetic evolution procedure for optimizing routing of light-trees for a given set of multicast traffic demands in said FWDM network; and
a simulated annealing procedure to address wavelength assignment and spectrum allocation problems in said FWDM network
wherein said genetic evolution procedure comprises a genetic encoding to map a chromosome to a potential solution of said routing sub-problem, a set of light-trees for a given set of traffic demands in said FWDM network representing a chromosome, and an individual light tree within this given set representing a gene, each gene corresponding to a feasible light-tree, and
wherein said simulated annealing procedure comprises a configuration C defined as an order of auxiliary demands in which the wavelength and spectrum allocation sub-problems are addresses and an optimization parameter function of C defined as an energy function to be minimized represents a maximum required spectrum over a fiber link including guard bands and fragmentation in observance of wavelength and spectral constraints.

15. The network of claim 14, wherein solving a light-tree establishment problem comprises finding routes of light-trees using said generic evolution method for evaluating feasible routing solutions, and selecting a solution that minimizes the total required spectrum in the network.

16. The network of claim 14, wherein solving a light-tree establishment problem comprises allocating spectrum and assigning wavelengths using said simulated annealing method with wavelength assignment and spectrum allocation sub-problems being addressed using a first-fit spectrum allocation procedure in various orders of demands through simulated annealing method.

17. The network of claim 14, wherein solving alight-tree establishment problem comprises finding K-alternate Steiner trees using application of K-alternate shortest routes.

18. The network of claim 14, wherein solving a light-tree establishment problem in comprises evaluating fitness of a chromosome by finding a total required spectrum by demands over a fiber link while ignoring the wavelength and spectral continuity constraints, a maximum required spectrum among all links in the network representing a fitness of a chromosome.

19. The network of claim 14, wherein solving alight-tree establishment problem comprises evaluating energy of said configuration by finding a total required spectrum by demands routed over a fiber link while observing the wavelength and spectral continuity constraints using a first-fit spectrum allocation procedure, a maximum required spectrum among all links in the network representing an energy of said configuration.

20. The network of claim 14, wherein solving a light-tree establishment problem in comprises mutation in said generic evolution method wherein trees selected based on a given mutation ratio are replaced by one of K-alternate Steiner trees of a respective demand randomly depending on a mutation probability.
